(19) United States
(12) Patent Application Publication
(10) Pub. No.: US 2007/0044849 A1
(43) Pub. Date: Mar. 1, 2007

(54) Intake device

(75) Inventors: Masamichi Akagawa, Kariya-city (JP); Tsuyoshi Arai, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/511,388

(22) Filed: Aug. 29, 2006

(30) Foreign Application Priority Data
Aug. 31, 2005 (JP) 2005-251282

(51) Int. Cl. F16K 11/072

(52) U.S. Cl. 137/595

(57) ABSTRACT

An intake device has a passage member defining a fluid passage, a housing, a valve member and a shaft member. The housing is disposed in the passage member such that a passage of the housing is in communication with the fluid passage of the passage member. The valve member is disposed in the housing to open and close the passage of the housing. The valve member has a tubular portion and a wing portion extending from the tubular portion. The shaft member is disposed to pass through the passage member and the tubular portion of the valve member in a direction perpendicular to an axis of the fluid passage of the passage member. The shaft member is disposed such that a portion of the shaft member located inside of the tubular portion retains an elastic force against an inner wall of the tubular portion.

### CROSS REFERENCE TO RELATED APPLICATION

This application is based on Japanese Patent Application No. 2005-251282 filed on Aug. 31, 2005, the disclosure of which is incorporated herein by reference.

### FIELD OF THE INVENTION

The present invention relates to an intake device for an engine, and particularly relates to an intake device having a valve member.

### BACKGROUND OF THE INVENTION

An intake device having valve members for changing a flow of intake air is for example known in DE19504256 C2. In the intake device, resinous valve members are rotatably supported by a metallic shaft. Each valve member is disposed to a corresponding one of intake air passages of an intake manifold. The valve members are actuated through the single shaft member. The shaft member is for example press-fitted into the valve members. As such, the valve members are fixed to the shaft member according to elastic forces of the valve members.

In such an intake device, if a temperature around an engine in which the intake device is mounted increases, the valve members, which are made of resin, are likely to loosen from the shaft member due to such as thermal expansion. As such, the elastic forces of the valve members against the shaft member reduces, and the valve members are unstable and wobble against the shaft member. As a result, air is likely to leak through gaps created between the valve members and the intake manifold due to the wobble, resulting in deterioration of power output of an engine. Further, the valve members are likely to abnormally vibrate against the shaft member due to pulsation of the intake air in the engine. This will result in partial wear of the valve members.

### SUMMARY OF THE INVENTION

The present invention is made in view of the foregoing matter, and it is an object of the present invention to provide an intake device capable of restricting a valve member from loosening from a shaft member due to a change of temperature.

According to an aspect of the present invention, an intake device has a passage member, a housing, a valve member and a shaft member. The passage member defines a fluid passage therein. The housing has a tubular shape and defines a passage therein. The housing is disposed in the passage member such that the passage of the housing is in communication with the fluid passage of the passage member. The valve member has a tubular portion defining a shaft hole therein and a wing portion extending from the tubular portion in a radially outward direction with respect to an axis of the tubular portion. The valve member is rotatably disposed in the housing to open and close the passage of the housing. The shaft member is disposed to pass through the passage member in a direction substantially perpendicular to an axis of the fluid passage. Further, the shaft member passes through the shaft hole of the tubular portion of the valve member to rotatably support the shaft member in the housing. The shaft member is disposed such that a portion located inside of the tubular portion retains an elastic force that presses against an inner wall of the tubular portion in the radially outward direction, the inner wall defining the shaft hole.

Accordingly, the shaft member supports the valve member in a condition that the portion of the shaft member located in the inside of the tubular portion elastically presses against the inner wall of the tubular portion in the radially outward direction. Namely, when the shaft member is inserted in the tubular portion, the shaft member presses the inner wall of the tubular portion from the inside to the outside. As such, even if a dimension of the valve member changes with temperature around an engine, the valve member is fixed on the shaft member with the elastic force generated by the shaft member, in addition to a compression force generated by the tubular portion of the valve member to the shaft member. Therefore, it is less likely that the shaft member will loosen from the shaft member due to a change of temperature.

Further, it is less likely that air will leak through a gap defined between the valve member and the housing due to the loosening. Moreover, since the valve member is stably fixed to the shaft member irrespective of the change of temperature, vibration of the valve member due to pulsation of an intake air of the engine will be reduced. With this, a power decrease of the engine will be reduced. In addition, it is less likely that the valve member will be partially worn.

### BRIEF DESCRIPTION OF THE DRAWINGS

Other objects, features and advantages of the present invention will become more apparent from the following detailed description made with reference to the accompanying drawings, in which like parts are designated by like reference numbers and in which:

FIG. 1 is a cross-sectional view of an intake device, taken along a line I-I in FIG. 3, according to a first example embodiment of the present invention;

FIG. 2 is a schematic perspective view of the intake device according to the first example embodiment of the present invention;

FIG. 3 is a schematic cross-sectional view of the intake device taken in a direction perpendicular to a longitudinal direction of a shaft of the intake device, according to the first example embodiment of the present invention;

FIG. 4 is a schematic perspective view of the shaft of the intake device according to the first example embodiment of the present invention;

FIG. 5A is a schematic explanatory view of a shaft formed by joining two members according to the first example embodiment of the present invention;

FIG. 5B is a schematic explanatory view of a shaft formed by folding a single member according to the first example embodiment of the present invention;

FIG. 6 is a schematic cross-sectional view of an intake device according to a second example embodiment of the present invention;

FIG. 7 is a schematic perspective view of a shaft of the intake device according to the second example embodiment of the present invention;

FIG. 8A is a cross-sectional view of an intake device according to a third example embodiment of the present invention; and

FIG. 8B is a schematic side view of a shaft of the intake device according to the third example embodiment of the present invention.

### DETAILED DESCRIPTION OF EXAMPLE EMBODIMENT

### First Example Embodiment

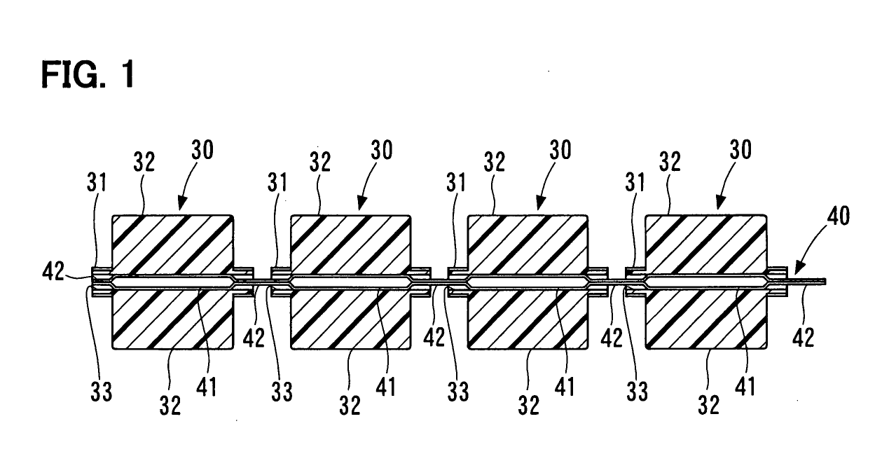

A first example embodiment of an intake device will be described with reference to FIGS. 1 to 5B. For example, the intake device 10 shown in FIGS. 1 to 3 is disposed on an outlet of a surge tank (not shown). Air that has been drawn into the surge tank flows in the intake device 10 as shown by an arrow A1 in FIG. 3.

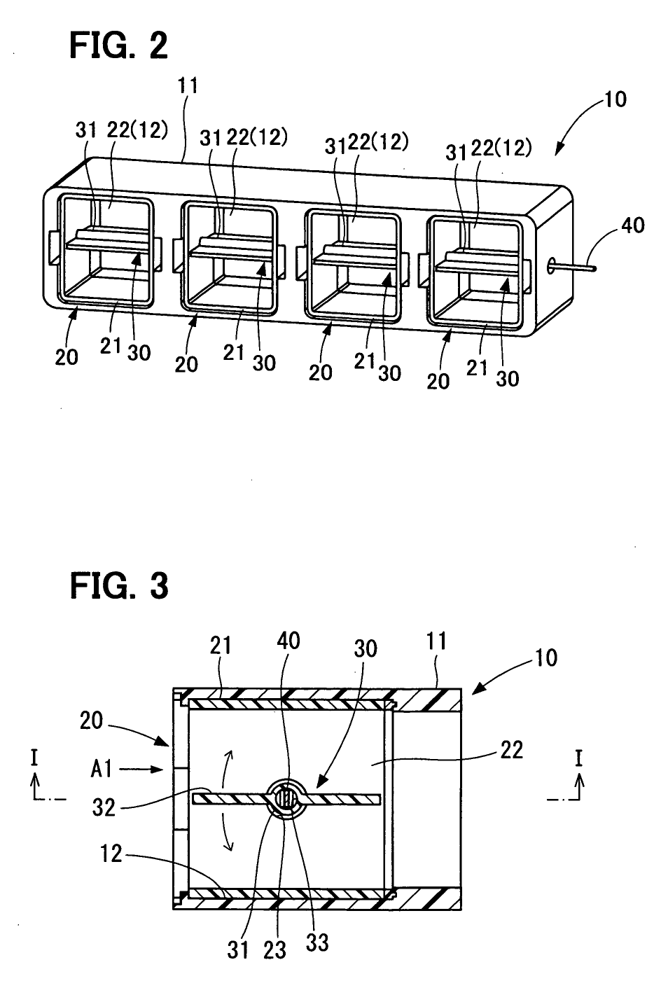

Referring to FIG. 2, the intake device 10 is constructed of an intake manifold 11, valve units 20, and a shaft 40. The intake manifold 11 is for example made of resin. The intake manifold 11 forms air passages 12 as a passage member. In the first example embodiment, the intake device 10 is for example used for an engine having four cylinders. Therefore, the intake manifold 11 forms four air passages 12. The air passages 12 allow communication between the surge tank and the engine.

Each of the valve units 20 is housed in a corresponding one of the air passages 12 of the intake manifold 11. Each valve unit 20 is constructed of a housing 21 and a butterfly member 30 as a valve member. The housing 21 has a tubular shape and defines a passage 22 therein. The housing 12 has a shape corresponding to a shape of the air passage 12 of the intake manifold 11, in a cross sectional plane defined perpendicular to an axis of the air passage 12.

In the first example embodiment, the air passage 12 of the intake manifold 11 for example has a substantially rectangular-shaped cross-section. Therefore, the housing 21 has a substantially rectangular shape to correspond to the shape of the air passage 12. Further, the housing 21 is slightly smaller than the air passage 12 to be inserted in the air passage 12. The housing 21 is arranged in the intake manifold 11 such that the passage 22 of the housing 21 is in communication with the air passage 12 of the intake manifold 11.

The butterfly member 30 is disposed inside of the housing 21. Also, the butterfly member 30 is rotatably supported by the shaft 40 to open and close the passage 22 of the housing 21. The housing 21 and the butterfly member 30 are made of a resin.

As shown in FIGS. 1 and 3, each butterfly member 30 has a tubular portion 31 and wing portions 32. The tubular portion 31 has a cylindrical shape, for example. The tubular portion 31 is formed at a substantially middle position of the butterfly member 30 with respect to an axis of the passage 22. The tubular portion 31 extends in a direction perpendicular to the axis of the passage 22. Further, the tubular portion 31 protrudes from ends of the butterfly member 30 in the direction perpendicular to the axis of the passage 22, as shown in FIG. 1.

Also, the tubular portion 31 forms a shaft hole 33 for passing through the shaft 40 therein, as shown in FIG. 3. Ends of the tubular portion 31, which protrudes from the ends of the butterfly member 30, are supported in support holes 23 that are formed on side walls of the housing 21. Each of the ends of the tubular portion 31 has an outer diameter slightly smaller than an inner diameter of the support hole 23. Therefore, the butterfly member 30 is rotatably supported through the support holes 23 of the housing 21.

Each butterfly member 30 has two wing portions 32, for example. The wing portions 32 extend from the tubular portion 31 in a radially outward direction with respect to an axis of the tubular portion 31 and in opposite directions to each other. Thus, the wing portions 32 are rotatable with the tubular portion 31. A total area of the wing portions 32, i.e., an area of the butterfly member 30 is substantially equal to a sectional area (flow area) of the passage 22 of the housing 21. Therefore, the passage 22, i.e., air passage 12 is opened and closed according to the rotational movement of the butterfly member 30.

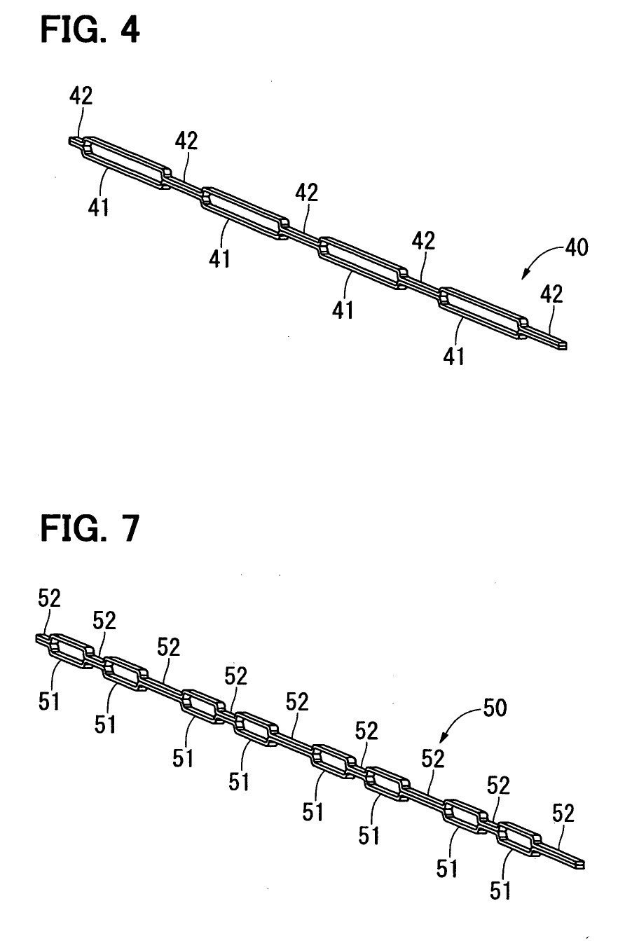

The shaft 40 is made of a metal such as stainless steel. As shown in FIG. 2, the shaft 40 is disposed to pass through the intake manifold 11 and valve units 20 in a direction substantially perpendicular to the axis of the air passages 12. As shown in FIGS. 1 and 4, the shaft 40 has first portions (large diameter portions) 41 and second portions (small diameter portions) 42. Further, the first portions 41 and the second portions 42 are formed alternately in a longitudinal direction of the shaft 40. Namely, the shaft 40 has the first portions 41 at positions corresponding to the inside of the butterfly members 30.

Before fixed to the intake manifold 11, i.e., in an original condition of the shaft 40, each first portion 41 has an outer dimension (e.g., width) slightly larger than an inner dimension of the tubular portion 31, i.e., a dimension of the shaft hole 33. Further, each second portion 42 has an outer dimension (e.g., width) smaller than the outer dimension of the first portion 41 and the inner dimension of the tubular portion 31. Also, a length of the first portion 41 is substantially equal to a dimension (width) of the butterfly member 30 with respect to the longitudinal direction of the shaft 40.

The shaft 40 is inserted in the shaft holes 33 of the tubular portions 31. At this time, each first portion 41 is inserted in the tubular portion 31 while being compressed by an inner wall of the tubular portion 31 in a radially inward direction of the tubular portion 31, the inner wall defining the shaft hole 33. As such, the first portion 41 provides a deformable portion that can be deformed radially inwardly in the tubular portion 31.

As shown in FIG. 4, the first portion 41 has a polygonal loop shape having a hollow therein, for example. The first portion 41 includes two bar-like portions extending substantially parallel in the longitudinal direction of the shaft 40. The bar-like portions are spaced from each other.

When an external force is applied to the first portion 41, the first portion 41 easily deflects or deforms such that the two bar-like portions becomes close to each other, i.e., the hollow space reduces. By the deflection or deformation, the first portion 41 generates an elastic force in an outward direction, e.g., in a direction that the deflected or deformed bar-like portions return to the original shape.

Therefore, when the shaft 40 is inserted in the tubular portion 31, the first portion 41 is compressed by the inner wall of the tubular portion 31 in the radially inward direction of the tubular portion 31 and generates a force pressing against the inner wall in the radially outward direction by its elasticity. As such, the first portion 41 is held in the shaft hole 33 in a condition of retaining the elastic force, i.e., pressing against the inner wall of the tubular portion 31 in the radially outward direction.

The shaft 40 is inserted in the intake manifold 11 and the valve units 30 such that the first portions 41 are located inside of the tubular portions 31 and the second portions 42 are located between the adjacent valve units 30.

Accordingly, in the first example embodiment, when the shaft 40 is inserted in the tubular portions 31, the tubular portions 31 compress the first portions 41 in the radially inward direction. In response to this, the first portions 41 press against the inner walls of the tubular portions in the radially outward direction. Namely, the first portions 41 are held in the tubular portions 31 while retaining the elastic forces against the tubular portions 31.

When a temperature around the intake device 10 is low and a compression force by the tubular portion 31 is large, the butterfly members 30 are fixed to the shaft 40 by the compression force of the tubular portions 31. On the contrary, when the temperature around the intake device 10 is high, the resinous butterfly members 30 are thermally expanded. In this case, the compression force of the tubular portions 31 against the first portions 41 of the shaft 40 is reduced. However, the first portions 41 can press against the inner walls of the tubular portions 31 by the own elasticity. Accordingly, even if the temperature around the intake device 10 is high, the butterfly members 30 are fixed to the shaft 40 by the elastic force of the shaft 40.

According to the above structure, even when the temperature around the intake device 10 is increased, it is less likely that the butterfly members 30 will loosen from and wobble against the shaft 40. As such, the butterfly members 30 are stably held on the shaft 40. Further, it is less likely that air will leak through gaps defined between the butterfly members 30 and the housings 21 due to the loosening or the wobble of the butterfly members 30.

Further, since the butterfly members 30 are stably held on the shaft 40, it is less likely that the butterfly members 30 will vibrate, even if the intake air passing through the air passages 12 are pulsated. Therefore, it is less likely that the butterfly members 30 and the housings 21 will be partly worn due to vibrations.

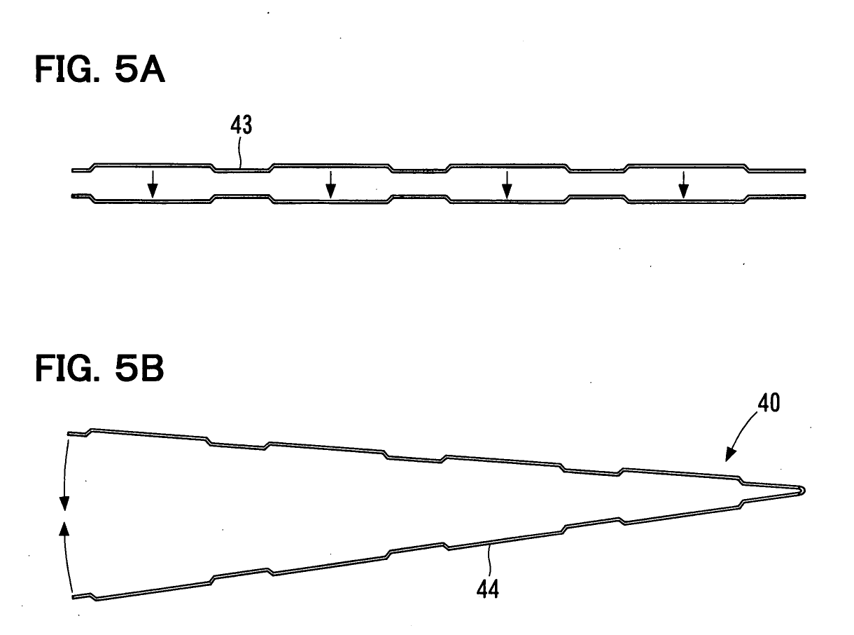

For example, the shaft 40 is formed by joining two symmetrical members 43 having shapes shown in FIG. 5A. Alternatively, the shaft 40 is formed by folding a single member 44, as shown in FIG. 5B. However, the shaft 40 can be formed by other ways. For example, the shaft 40 can be formed by punching or pressing a plate member.

### Second Example Embodiment

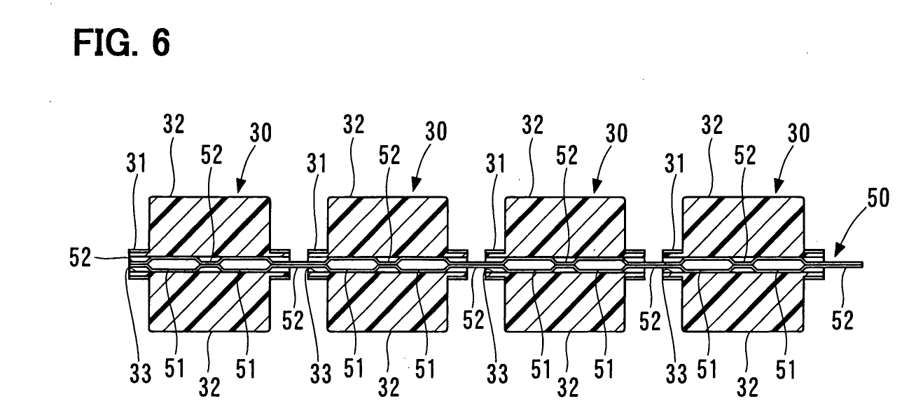

A second example embodiment of the intake device 10 will be described with reference to FIGS. 6 and 7. Here, like components are denoted by like reference characters and a description thereof is not repeated.

As shown in FIGS. 6 and 7, the intake device 10 has a shaft 50 that has a shape different from that of the shaft 40 of the first example embodiment. The shaft 50 has first portions 51 and second portions 52. The first portions 51 and the second portions 52 are alternately arranged in a longitudinal direction of the shaft 50.

In an original condition that the shaft 50 is not inserted in the intake manifold 11, each first portion 51 has an outer dimension (e.g., width) slightly larger than an inner dimension of the tubular portion 31, i.e., a dimension of the shaft hole 33. Further, each second portion 52 has an outer dimension (e.g., width) that is smaller than the outer dimension of the first portion 51 and the inner dimension of the tubular portion 31. Here, the number of the first portions 51 located in the shaft hole 33 of each butterfly member 30 is larger than that of the first portion 41 of the shaft 40.

Namely, when the shaft 50 is inserted in the intake manifold 11 and the valve units 20, two first portions 51 are disposed in each tubular portions 31. Also, a length of each first portion 51 is substantially equal to or shorter than a half width of the butterfly member 30 with respect to the longitudinal direction of the shaft 50. Also, the second portion 52 is formed between adjacent first portions 51.

In the second example embodiment, the number of the first portions 51 disposed in each tubular portion 31 is increased and the width of each first portion 51 is decreased, as compared to those of the first example embodiment. As such, a total contact area between the first portions 51 and the tubular portions 31 is smaller than that of the first example embodiment. Therefore, when the shaft 50 is inserted in the tubular portions 31, a contact resistance between the shaft 50 and the tubular portions 31 reduces. Accordingly, the shaft 50 is more easily inserted in the tubular portions 31 of the butterfly members 30 than the shaft 40 of the first example embodiment.

Here, the number of the first portions 51 disposed in each tubular portion 31 is not limited to two. For example, more than three first portions 51 can be disposed in each tubular portion 31.

Further, in the shaft 40 and the shaft 50, the first portions 41, 51 have the polygonal loop shape. Alternatively, the first portions 41, 51 can have any shapes such as round shapes or ellipse as long as the elastic force can be produced.

### Third Example Embodiment

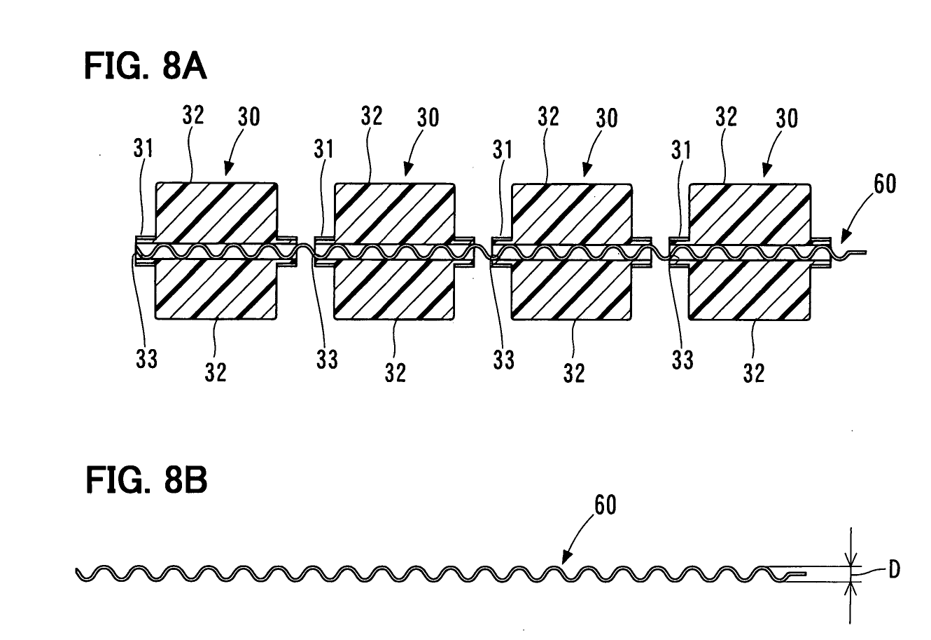

A third example embodiment will be described with reference to FIGS. 8A and 8B. Here, like components are denoted by like reference characters and a description thereof is not repeated.

As shown in FIGS. 8A and 8B, the intake device 10 has a shaft 60 having a wave form, instead of the shafts 40, 50. The shaft 60 has a width D slightly larger than the inner dimension of the tubular portion 31 in an original condition (shape). Therefore, when the shaft 60 is inserted in the tubular portions 31, the shaft 60 can deform in the radially inward direction of the tubular portions 31. Here, the width D is a dimension between an upper and a lower peaks of the wave form. Namely, the width D is a dimension measured in a direction perpendicular to a longitudinal direction of the shaft 60.

Accordingly, when the shaft 60 is inserted in each tubular portion 31, a portion located in the tubular portion 31 is compressed by the tubular portion 31 in the radially inward direction of the tubular portion 31. In response to this, the compressed portion of the shaft 60 generates the elastic force in the reverse direction.

In a condition that the shaft 60 is disposed in the tubular portion 31 of the butterfly member 30, the shaft 60 is compressed in the radially inward direction of the tubular portion 31 and retains the force pressing against the inner wall of the tubular portion 31 in the radially outward direction by the elasticity. As a result, the shaft 60 is held in a condition pressing the inner wall of the tubular portion 31 in the radially outward direction of the tubular portion 31.

In the third example embodiment, slackness between the butterfly member 30 and the shaft 60 is reduced. Further, a total contact area between the shaft 60 and the tubular portions 31 is further reduced, as compared to the second example embodiment. As such, the contact resistance generated when the shaft 60 is inserted in the tubular portions 31 is reduced. Therefore, the shaft 60 can be inserted in the tubular portions 31 more easily, as compared to the second example embodiment.

In the shaft 60 illustrated in FIGS. 8A and 8B, the wave shape is formed of a curved line. However, the wave form of the shaft 60 is not limited to the illustrated shape as long as the shaft 60 can be elastically deformed. For example, the wave form of the shaft 60 can be formed of straight lines or combinations of straight lines and curved lines.

In the above example embodiments, the butterfly member 30 has two wing portions 32 extending from the tubular portion 31 in opposite directions. However, the shape of the butterfly member 30 is not limited to the above. For example, the butterfly member 30 can be a cantilever-type valve member having one wing portion 31 extending from the tubular portion 31 in one direction.

In the above example embodiments, the intake manifold 11 has four air passages 12 to be used for the engine having four cylinders. However, the number of the air passages 12 is not limited to four.

In the above example embodiments, the air passages 12 of the intake manifold 11 have the substantially rectangular-shaped cross section. However, the cross-sectional shape of the air passages 12 is not limited to the substantially rectangular shape, but may be circular or round shapes. In such a case, the housings 21 and the butterfly members 30 have the shape corresponding to the shape of the air passages 12.

In the above example embodiments, the intake device 10 is arranged downstream of the surge tank. However, the arrangement position of the intake device 10 is not limited to the above. Further, a fluid passing through the passages 12, 22 are not limited to the intake air.

The example embodiments of the present invention are described above. However, the present invention is not limited to the above example embodiments, but may be implemented in other ways without departing from the spirit of the invention.

What is claimed is:

1. An intake device comprising:
a passage member defining a fluid passage through which a fluid flows;
a housing having a tubular shape and defining a passage therein, the housing disposed in the passage member such that the passage of the housing is in communication with the fluid passage of the passage member;
a valve member having a tubular portion defining a shaft hole therein and a wing portion extending from the tubular portion in a radially outward direction with respect to an axis of the tubular portion, the valve member rotatably disposed in the housing to open and close the passage of the housing; and
a shaft member disposed to pass through the passage member in a direction substantially perpendicular to an axis of the fluid passage of the passage member, wherein
the shaft member further passes through the shaft hole of the tubular portion of the valve member to rotatably support the valve member in the housing, and
the shaft member retains an elastic force that presses against an inner wall of the tubular portion, the inner wall defining the shaft hole.

2. The intake device according to claim 1, wherein
the shaft member has a deformable portion, and the deformable portion is compressed in the inside of the tubular portion in a radially inward direction of the tubular portion.

3. The intake device according to claim 2, wherein
the shaft member has at least one first portion and at least one second portion,
in a condition without being disposed in the tubular portion, the first portion has an outer dimension larger than an inner dimension of the tubular portion in a direction perpendicular to a longitudinal direction of the shaft member,
the first portion provides the deformable portion, and
the second portion has an outer dimension smaller than the inner dimension of the tubular portion in the direction perpendicular to the longitudinal direction of the shaft member.

4. The intake device according to claim 3, wherein
the shaft member has at least two first portions inside of the tubular portion.

5. The intake device according to claim 1, wherein
the shaft member has a wave form, and
a dimension of the wave form in a direction perpendicular to a longitudinal direction of the shaft member is larger than an inner dimension of the tubular portion, in a condition that the shaft member is not disposed in the tubular portion.

6. The intake device according to claim 1, wherein
the shaft member supports the valve member in a condition that a portion of the shaft member is elastically deformed in an inside of the tubular portion.

7. The intake device according to claim 3, wherein
the first portion has a polygonal loop shape defining a hollow therein, and the first portion is elastically deformed in the inside of the tubular portion.

8. The intake device according to claim 1, further comprising a plurality of valve members including the valve member, wherein
the shaft member is disposed to pass through tubular portions of the plurality of valve members.

9. The intake device according to claim 8, wherein
the shaft member has a plurality of deformable portions each having an outer dimension larger than an inner dimension of the tubular portion in a condition without being disposed in the tubular portion,
the shaft portion is disposed such that at least one deformable portion is located in the tubular portion of each valve member, and
the deformable portions are elastically deformed in the tubular portions.

10. The intake device according to claim 8, further comprising:
a plurality of housings including the housing, wherein
the passage member defines a plurality of fluid passages including the fluid passage, and each of the plurality of housings is disposed in a corresponding one of the plurality of fluid passages, and
each of the plurality of valve members is disposed in a corresponding one of the plurality of housings.
